(19) United States
(12) Patent Application Publication
(10) Pub. No.: US 2024/0043672 A1
(43) Pub. Date: Feb. 8, 2024

(54) POLYOLEFIN COMPOSITION WITH HIGH TRANSPARENCY

(71) Applicant: Basell Poliolefine Italia S.r.l., Milano (IT)

(72) Inventors: Riccardo Fioravanti, Ferrara (IT); Mara Destro, Ferrara (IT); Gianluca Musacchi, Ferrara (IT)

(73) Assignee: Basell Poliolefine Italia S.r.l., Milano (IT)

(21) Appl. No.: 18/266,068

(22) PCT Filed: Dec. 10, 2021
(86) PCT No.: PCT/EP2021/085208

§ 371 Date: Jun. 8, 2023

(30) Foreign Application Priority Data
Dec. 15, 2020 (EP) 20214145.3

(51) Int. Cl. C08L 23/14

(52) U.S. Cl. CPC C08L 23/14; C08L 2201/10; C08L 2205/24

(57) ABSTRACT

A polyolefin composition having high transparency, made from or containing:
A) a propylene polymer, alternatively a heterophasic polyolefin composition made from or containing the propylene polymer and an ethylene copolymer;
B) from 0.01% to 2% by weight of a butene-1 polymer; and
C) a clarifying agent;
wherein the amounts are referred to the total weight of A)+B)+C).

### FIELD OF THE INVENTION

In general, the present disclosure relates to the field of chemistry. More specifically, the present disclosure relates to polymer chemistry. In particular, the present disclosure relates to a polyolefin composition made from or containing a propylene polymer.

### BACKGROUND OF THE INVENTION

Crystalline polyolefins are used in the production of finished or semi-finished articles. In some instances, the articles include injection-molded, extruded, or blow-molded articles, like containers, bottles, sheets, films, and fibers.

In some instances, the articles are for medical uses and for packaging, which seek transparency.

In some instances, adding a clarifying agent to propylene polymers facilitates transparency.

In some instances, the clarifying agent has a crystal nucleating effect on the propylene polymer when melted, formed, and cooled to obtain the final article. In some instances, a residual haze remains.

### SUMMARY OF THE INVENTION

In a general embodiment, the present disclosure provides a polyolefin composition made from or containing:
A) a propylene polymer;
B) from 0.01% to 2% by weight of a butene-1 polymer; and
C) a clarifying agent,
wherein the amounts are referred to the total weight of A)+B)+C). In some embodiments, component A is further made from or containing an ethylene polymer, thereby forming a heterophasic polyolefin composition.

In some embodiments, the present disclosure provides a polyolefin composition made from or containing:
A) a propylene polymer, alternatively a heterophasic polyolefin composition made from or containing the propylene polymer and an ethylene copolymer;
B) from 0.01% to 2% by weight, alternatively from 0.015% to 1.5% by weight, alternatively from 0.02% to 0.5% by weight, alternatively from 0.02% to 0.3% by weight, alternatively from 0.02% to 0.2% by weight, of a butene-1 polymer; and
C) a clarifying agent,
wherein the amounts are referred to the total weight of A)+B)+C).

### DETAILED DESCRIPTION OF THE INVENTION

It is believed that the addition of the butene-1 polymer B) reduces the haze of a polyolefin composition made from or containing components A) and C).

In some embodiments, the present disclosure provides a process for reducing the haze of a polyolefin composition made from or containing
A) a propylene polymer, alternatively a heterophasic polyolefin composition made from or containing the propylene polymer and an ethylene copolymer; and
C) a clarifying agent; including the step of

adding a butene-1 polymer B) to the polyolefin composition in an amount from 0.01% to 2% by weight, alternatively from 0.015% to 1.5% by weight, alternatively from 0.02% to 0.5% by weight, alternatively from 0.02% to 0.3% by weight, alternatively from 0.02% to 0.2% by weight, with respect to the total weight of A)+B)+C).

As used herein, the term “propylene polymer” includes polymers selected from the group consisting of propylene homopolymers, propylene copolymers, alternatively random copolymers, and mixtures thereof.

As used herein, the term “butene-1 polymer” includes polymers selected from the group consisting of butene-1 homopolymers, butene-1 copolymers, and mixtures thereof.

In some embodiments, propylene polymer A) is a propylene copolymer made from or containing one or more comonomer(s). In some embodiments, the comonomers are selected from the group consisting of ethylene and CH₂═CHR alpha-olefins, where R is a C₂-C₈ alkyl radical. In some embodiments, the comonomers are selected from the group consisting of butene-1, pentene-1, 4-methyl-pentene-1, hexene-1, and octene-1.

In some embodiments, the comonomers are selected from the group consisting of ethylene, butene-1, and hexene-1.

In some embodiments, the butene-1 polymer B) is a butene copolymer made from or containing one or more comonomer(s). In some embodiments, the comonomers are selected from the group consisting of ethylene, propylene, and CH₂═CHR alpha-olefins, where R is a C₃-C₈ alkyl radical. In some embodiments, the comonomers are selected from the group consisting of pentene-1, 4-methyl-pentene-1, hexene-1, and octene-1.

In some embodiments, the comonomers are selected from the group consisting of ethylene, propylene, and hexene-1.

As used herein, the term “copolymer” includes polymers containing more than one kind of comonomers.

In some embodiments, the propylene polymer A) is selected from the group consisting of propylene homopolymers and copolymers and has at least one of the following features:
being a propylene copolymer having a content of comonomer(s) from 0.5 to 15% by weight, alternatively from 1 to 12% by weight, alternatively from 0.5 to 6% by weight, wherein the comonomer is ethylene or hexene-1; or
a polydispersity Index (P.I.) equal to or higher than 4, alternatively from 4 to 20, alternatively from 4 to 15; or
a MIL from 0.1 to 400 g/10 min., alternatively from 0.5 to 150 g/10 min., alternatively from 10 to 100 g/10 min., where MIL is the melt flow index at 230° C. with a load of 2.16 kg, determined according to ISO 1133-2:2011; or
an amount of fraction insoluble in xylene at 25° C. equal to or higher than 85% by weight, alternatively equal to or higher than 90% by weight, alternatively the propylene polymer A) is made from or containing propylene homopolymers and has an amount of fraction insoluble in xylene at 25° C. equal to or higher than 95% by weight, alternatively the upper limit of the insoluble fraction is 99% by weight for the homopolymers, alternatively the upper limit of the insoluble fraction is 96% by weight for copolymers; or
a flexural modulus higher than 200 MPa, alternatively higher than 400 MPa, alternatively the upper limit is 2000 MPa.

In some embodiments, the propylene homopolymers and propylene copolymers are commercially available.

In some embodiments, the commercially-available homopolymers and copolymers of propylene are sold by the LyondellBasell Industries under the tradename Moplen.

In some embodiments, the propylene homopolymers and propylene copolymers are prepared by using a Ziegler-Natta catalyst or a metallocene-based catalyst system in the polymerization process.

In some embodiments, a Ziegler-Natta catalyst is made from or containing the product of the reaction of an organometallic compound of group 1, 2 or 13 of the Periodic Table of Elements with a transition metal compound of groups 4 to 10 of the Periodic Table of Elements (new notation). In some embodiments, the transition metal compound is selected from the group consisting of compounds of Ti, V, Zr, Cr and Hf. In some embodiments, the transition metal is supported on MgCl₂.

In some embodiments, catalysts are made from or containing the product of the reaction of the organometallic compound of group 1, 2 or 13 of the Periodic Table of Elements, with a solid catalyst component made from or containing a Ti compound and an electron donor compound supported on MgCl₂.

In some embodiments, the organometallic compounds are aluminum alkyl compounds.

In some embodiments, the Ziegler-Natta catalysts are made from or containing the product of reaction of:
1) a solid catalyst component made from or containing a Ti compound, alternatively a halogenated Ti compound, alternatively TiCl₄, and an electron donor (internal electron-donor) supported on MgCl₂;
2) an aluminum alkyl compound (cocatalyst); and, optionally,
3) an electron-donor compound (external electron-donor).

In some embodiments, the solid catalyst component (1) contains, as an electron-donor, a compound selected from the group consisting of ethers, ketones, lactones, compounds containing N, P and/or S atoms, and mono- and dicarboxylic acid esters.

In some embodiments, the catalysts are as described in U.S. Pat. No. 4,399,054 and European Patent No. 45977.

In some embodiments, the internal electron-donor compounds are selected from the group consisting of phthalic acid esters and succinic acid esters. In some embodiments, the phthalic acid ester is diisobutyl phthalate.

In some embodiments, the internal electron-donors are the 1,3-diethers described in European Patent Application Nos. EP-A-361493 and 728769.

In some embodiments, cocatalysts (2) are trialkyl aluminum compounds. In some embodiments, the trialkyl aluminum compounds are selected from the group consisting of Al-triethyl, Al-triisobutyl, and Al-tri-n-butyl.

In some embodiments, the electron-donor compounds (3) used as external electron-donors (added to the Al-alkyl compound) are selected from the group consisting of aromatic acid esters, heterocyclic compounds, and silicon compounds containing at least one Si—OR bond (where R is a hydrocarbon radical). In some embodiments, the aromatic acid esters are alkylic benzoates. In some embodiments, the heterocyclic compounds are selected from the group consisting of 2,2,6,6-tetramethylpiperidine and 2,6-diisopropylpiperidine.

In some embodiments, the silicon compounds are selected from the group consisting of (tert-butyl)₂Si(OCH₃)₂, (cyclohexyl)(methyl) Si (OCH₃)₂, (phenyl)₂Si(OCH₃)₂ and (cyclopentyl)₂Si(OCH₃)₂.

In some embodiments, the 1,3-diethers are used as external electron-donors. In some embodiments, the internal electron-donor is a 1,3-diether, and the external electron-donor is omitted.

In some embodiments, the catalysts are precontacted with small quantities of olefin (prepolymerization), maintaining the catalyst in suspension in a hydrocarbon solvent, and polymerizing at temperatures from room to 60° C., thereby producing a quantity of polymer from 0.5 to 3 times the weight of the catalyst.

In some embodiments, the operation takes place in liquid monomer, producing a quantity of polymer up to 1000 times the weight of the catalyst.

In some embodiments, the metallocene-based catalyst systems are as described in United States Patent Application Publication No. US20060020096 and Patent Cooperation Treaty Publication No. WO98040419.

In some embodiments, the polymerization is carried out in a single step, or in two or more steps under different polymerization conditions.

In some embodiments, the polymerization occurs in liquid phase (for example, using liquid propylene as diluent), in gas phase or liquid-gas phase.

In some embodiments, molecular weight regulators are used. In some embodiments, the molecular weight regulators are chain transfer agents. In some embodiments, the chain transfer agents are hydrogen or ZnEt₂.

In some embodiments, the polymerization temperature is from 40 to 120° C.; alternatively from 50 to 80° C.

In some embodiments, the polymerization pressure is atmospheric or higher.

In some embodiments, the polymerization is carried out in liquid propylene and the pressure competes with the vapor pressure of the liquid propylene at the operating temperature used. In some embodiments, the pressure is modified by the vapor pressure of the inert diluent used to feed the catalyst mixture, by the overpressure of optional monomers, and by the hydrogen used as a molecular weight regulator.

In some embodiments, the propylene polymer A) is produced by a polymerization process carried out in a gas-phase polymerization reactor including at least two interconnected polymerization zones as described in European Patent No. 782587.

In some embodiments, the process is carried out in first and second interconnected polymerization zones into which propylene and the optional comonomers are fed in the presence of the catalyst system and from which the polymer produced is discharged. The growing polymer particles flow upward through the first polymerization zones (riser) under fast fluidization conditions, leave the riser, enter the second polymerization zone (downcomer), flow downward in a densified form under the action of gravity through the downcomer, leave the downcomer, and are reintroduced into the riser, thereby establishing a circulation of polymer between the riser and the downcomer.

In the downcomer, the density of the solid approaches the bulk density of the polymer. In some embodiments, a positive gain in pressure obtained along the direction of flow, thereby permitting reintroduction of the polymer into the riser without the help of mechanical devices. In this way, a “loop” circulation is set up, which is defined by the balance of pressures between the two polymerization zones and by the head loss introduced into the system.

In some embodiments, the condition of fast fluidization in the riser is established by feeding a gas mixture made from or containing the relevant monomers to the riser. In some embodiments, the feeding of the gas mixture is effected below the point of reintroduction of the polymer into the riser by a gas distributor. In some embodiments, the velocity of the transport gas into the riser is higher than the transport velocity under the operating conditions, alternatively from 2 to 15 m/s.

In some embodiments, the polymer and the gaseous mixture leaving the riser are conveyed to a solid/gas separation zone for separation. From the separation zone, the polymer enters the downcomer. The gaseous mixture leaving the separation zone is compressed, cooled, and transferred to the riser. In some embodiments, the gaseous mixture is supplemented with make-up monomers or molecular weight regulators. In some embodiments, the transfer occurs via a recycle line for the gaseous mixture.

In some embodiments, the control of the polymer circulation between the two polymerization zones occurs by metering the amount of polymer leaving the downcomer through controlling the flow of solids. In some embodiments, the control of flow is achieved with mechanical valves.

In some embodiments, the process is carried out under operating pressures between 0.5 and 10 MPa, alternatively between 1.5 to 6 MPa.

In some embodiments, one or more inert gases are maintained in quantities in the polymerization zones, such that the sum of the partial pressures of the inert gases is between 5 and 80% of the total pressure of the gases. In some embodiments, the inert gas is nitrogen or an aliphatic hydrocarbon.

In some embodiments, the catalyst is fed to the riser at any point of the riser. In some embodiments, the catalyst is fed at any point of the downcomer. In some embodiments, the catalyst is in any physical state. In some embodiments, the catalysts are in either solid or liquid state.

In some embodiments, the heterophasic polyolefin composition A) are compositions made from or containing:
i) one or more propylene polymers selected from the group consisting of propylene homopolymers, propylene copolymers, and mixtures thereof, and
ii) a copolymer or a composition of copolymers of ethylene with propylene or one or more CH₂═CHR alpha-olefin(s), where R is a C₂-C₈ alkyl radical, and optionally with minor amounts of a diene, wherein the copolymer or the composition contains 15% by weight or more, alternatively from 15% to 90% by weight, alternatively from 25 to 85% by weight, of ethylene with respect to the weight of ii). In some embodiments, the diene is present in an amount from 1 to 10% by weight with respect to the weight of ii).

In some embodiments, the heterophasic polyolefin composition contain from 40 to 90% by weight of component i) and 10 to 60% by weight of component ii), referred to the total weight of i)+ii).

In some embodiments, the CH₂═CHR alpha-olefin is present in an amount from 0.5 to 15% by weight, alternatively from 1 to 12% by weight, alternatively from 0.5 to 6% by weight.

In some embodiments, the CH₂═CHR alpha-olefin is butene-1.

In some embodiments, the dienes are selected from the group consisting of butadiene, 1,4-hexadiene, 1,5-hexadiene, and ethylidene-1-norbornene.

In some embodiments, the heterophasic polyolefin composition A) has a MIL ranging from 0.1 to 50 g/10 minutes, alternatively from 0.5 to 20 g/10 minutes.

In some embodiments, the elongation at break of the heterophasic polyolefin composition is from 100% to 1000%.

In some embodiments, the flexural modulus of the heterophasic polyolefin composition is from 500 to 1500 MPa, alternatively from 700 to 1500 MPa.

In some embodiments, the copolymer or the composition of copolymers ii) has a solubility in xylene at 25° C. of from 40% to 100% by weight, alternatively from 50% to 100% by weight, referred to the total weight of ii).

In some embodiments, the heterophasic polyolefin compositions are commercially available.

In some embodiments, the heterophasic polyolefin compositions are commercially available from LyondellBasell Industries under the tradename Moplen.

In some embodiments, the heterophasic polyolefin compositions are prepared by blending components i) and ii) in the molten state, that is, at temperatures greater than the components' softening or melting point, alternatively by sequential polymerization in the presence of a Ziegler-Natta catalyst.

In some embodiments, the catalysts are metallocene-type catalysts, as described in U.S. Pat. No. 5,324,800 and European Patent Application No. EP-A-0129368; alternatively bridged bis-indenyl metallocenes. In some embodiments, the metallocene catalysts are as described in U.S. Pat. No. 5,145,819 and European Patent Application No. EP-A-0485823. In some embodiments, the metallocene catalysts are used to prepare the component ii).

In some embodiments, the sequential polymerization process for the production of the heterophasic polyolefin composition includes at least two stages, where, in one or more stage(s), propylene is polymerized, optionally in the presence of the CH₂═CHR alpha-olefin comonomer(s), to form component i), and, in one or more additional stage(s), mixtures of ethylene with propylene or the CH₂═CHR alpha-olefin comonomer(s), and optionally dienes, are polymerized to form component ii).

In some embodiments, the polymerization process is carried out in liquid, gaseous, or liquid/gas phase. In some embodiments, the polymerization temperature in the various stages of polymerization is equal or different. In some embodiments, the reaction temperature for preparing component (i) ranges from 40 to 90° C., alternatively from 50 to 80° C. In some embodiments, the reaction temperature for preparing component (ii) ranges from 40 to 60° C. In some embodiments, the sequential polymerization processes are as described in European Patent Application Nos. EP-A-472946 and EP-A-400333 and Patent Cooperation Treaty Publication No. WO03/011962.

In some embodiments, the butene-1 polymer B) is a linear polymer which is highly isotactic. In some embodiments, the butene-1 polymer B) has an isotacticity from 90 to 99%, alternatively from 93 to 99%, alternatively from 95 to 99%, measured as mmmm pentads/total pentads with ¹³C-NMR operating at 150.91 MHz, or as quantity by weight of matter soluble in xylene at 0° C.

In some embodiments, the butene-1 polymer B) has a MIE value of from 1 to 3000 g/10 min., alternatively from 50 to 3000 g/10 min., where MIE is the melt flow index at 190° C. with a load of 2.16 kg, determined according to ISO 1133-2:2011.

In some embodiments, the MIE values for the butene-1 polymer B) are from 700 to 3000 g/10 min.

In some embodiments, the butene-1 polymer B) is a copolymer having a comonomer content of from 0.5% to 5.0% by mole, alternatively from 0.7% to 3.5% by mole. In some embodiments, the comonomer is ethylene

In some embodiments, the butene-1 polymer B) is a butene-1 polymer composition made from or containing:
B1) a butene-1 homopolymer or a copolymer of butene-1 with a comonomer selected from the group consisting of ethylene, propylene, CH₂═CHR alpha-olefin, and mixtures thereof, having a copolymerized comonomer content of up to 2% by mole; and
B2) a copolymer of butene-1 with a comonomer selected from the group consisting of ethylene, propylene, CH₂═CHR alpha-olefin, and mixtures thereof, having a copolymerized comonomer content of from 3 to 5% by mole;
wherein the butene-1 polymer composition having a total copolymerized comonomer content of 0.5-4.0% by mole, alternatively from 0.7 to 3.5% by mole, referred to the sum of B1)+B2).

In some embodiments, the relative amounts of B1) and B2) range from 10% to 40% by weight, alternatively from 15% to 35% by weight, of B1) and from 90% to 60% by weight, alternatively from 85% to 65% by weight, of B2), wherein the amounts being referred to the sum of B1)+B2).

In some embodiments, the butene-1 polymer B) has at least one of the following features:
a) a molecular weight distribution (Mw/Mn) equal to or lower than 9, alternatively equal to or lower than 4, alternatively equal to or lower than 3, alternatively equal to or lower than 2.5; or
b) a melting point TmII, measured by DSC (Differential Scanning calorimetry) in the second heating run with a scanning speed of 10° C./min., equal to or lower than 125° C., alternatively equal to or lower than 110° C.; or
c) a Brookfield viscosity at 190° C. of from 1500 to 20000 mPa·sec, alternatively from 2000 to 15000 mPa·sec, alternatively from 2500 to 10000 mPa·sec; or
d) 4,1 insertions not detectable using a ¹³C-NMR operating at 150.91 MHz; or
e) X-ray crystallinity of from 25 to 65%; or
f) a glass transition temperature (Tg) from −40° C. to −10° C., alternatively from −30° C. to −10° C. In some embodiments, the lower limit for the molecular weight distribution is 1.5. In some embodiments, the lower limit for the melting point TmII is 80° C.

In some embodiments, the butene-1 polymer B) has at least one of the following features:
i) an intrinsic viscosity (I.V.) measured in tetrahydronaphthalene (THN) at 135° C., equal to or lower than 5 dl/g, alternatively equal to or lower than 2 dl/g, alternatively equal to or lower than 0.6 dl/g; or
ii) a Mw equal to or greater than 30.000 g/mol, alternatively from 30.000 to 500.000 g/mol, alternatively from 30.000 to 100.000 g/mol; or
iii) a melting point TmI, measured by DSC with a scanning speed of 10° C./min., from 95° C. to 110° C.; or
iv) a density of 0.885-0.925 g/cm³, alternatively 0.890-0.920 g/cm³. In some embodiments, the lower limit of the intrinsic viscosity is 0.2 dl/g.

In some embodiments, the butene-1 polymer B) is produced using TiCl3 based Ziegler-Natta catalysts and aluminum derivatives as cocatalysts. In some embodiments, the aluminum derivatives are aluminum halides. In some embodiments, catalytic systems supported on MgCl2 are used for the preparation of the propylene polymer A).

In some embodiments, supported catalytic systems are used with internal electron-donor compounds selected from diethyl or diisobutyl 3,3-dimethyl glutarate.

In some embodiments, external electron-donor compounds are selected from the group consisting of cyclohexyltrimethoxysilane, t-butyltrimethoxysilane diisopropyltrimethoxysilane, and thexyltrimethoxysilane. In some embodiments, the external electron-donor compound is thexyltrimethoxysilane.

In some embodiments, the butene-1 polymer B) is obtained by polymerizing the monomer(s) in the presence of a metallocene catalyst system obtainable by contacting:
a stereorigid metallocene compound;
an alumoxane or a compound capable of forming an alkyl metallocene cation; and, optionally,
an organo aluminum compound.

In some embodiments, the stereorigid metallocene compound belongs to the following formula (I):

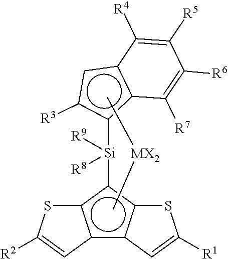

wherein:
M is an atom of a transition metal selected from group 4; alternatively M is zirconium;
X, equal to or different from each other, is a hydrogen atom, a halogen atom, a R, OR, OR′O, OSO₂CF₃, OCOR, SR, NR₂ or PR₂ group wherein R is a linear or branched, saturated or unsaturated C₁-C₂₀-alkyl, C₃-C₂₀-cycloalkyl, C₆-C₂₀-aryl, C₇-C₂₀-alkylaryl or C₇-C₂₀-arylalkyl radical, optionally containing heteroatoms belonging to groups 13-17 of the Periodic Table of the Elements; and R′ is a C₁-C₂₀-alkylidene, C₆-C₂₀-arylidene, C₇-C₂₀-alkylarylidene, or C₇-C₂₀-arylalkylidene radical;
R¹, R², R⁵, R⁶, R⁷, R⁸ and R⁹, equal to or different from each other, are hydrogen atoms, or linear or branched, saturated or unsaturated C₁-C₂₀-alkyl, C₃-C₂₀-cycloalkyl, C₆-C₂₀-aryl, C₇-C₂₀-alkylaryl or C₇-C₂₀-arylalkyl radicals, optionally containing heteroatoms belonging to groups 13-17 of the Periodic Table of the Elements; alternatively R⁵ and R^{6 ,} or R⁸ and R⁹ form a saturated or unsaturated, 5 or 6 membered rings, providing that at least one of R⁶ or R⁷ is a linear or branched, saturated or unsaturated C₁-C₂₀-alkyl radical, optionally containing heteroatoms belonging to groups 13-17 of the Periodic Table of the Elements;
R³ and R⁴, equal to or different from each other, are linear or branched, saturated or unsaturated C₁-C₂₀-alkyl radicals, optionally containing heteroatoms belonging to groups 13-17 of the Periodic Table of the Elements. In some embodiments, X is a hydrogen atom, a halogen atom, or a OR′O or R group. In some embodiments, X is chlorine or a methyl radical. In some embodiments, the R⁵-R⁶ or R⁸-R⁹ ring bears C₁-C₂₀ alkyl radicals as substituents. In some embodiments, R⁶ or R⁷ is a C₁-C₁₀-alkyl radical. In some embodiments, R³ and R⁴, equal to or different from each other, are C₁-C₁₀-alkyl radicals. In some embodiments, R³ is a methyl or ethyl radical. In some embodiments, R⁴ is a methyl, ethyl, or isopropyl radical.

In some embodiments, the compounds of formula (I) have formula (Ia):

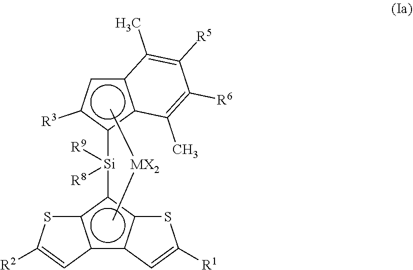

Wherein:
M, X, R¹, R², R⁵, R⁶, R⁸ and R⁹ are as described above;
R³ is a linear or branched, saturated or unsaturated C₁-C₂₀-alkyl radical, optionally containing heteroatoms belonging to groups 13-17 of the Periodic Table of the Elements; alternatively R³ is a C₁-C₁₀-alkyl radical; alternatively R³ is a methyl or ethyl radical.

In some embodiments, the metallocene compounds are selected from the group consisting of dimethylsilyl {(2,4,7-trimethyl-1-indenyl)-7-(2,5-dimethyl-cyclopenta[1,2-b:4,3-b']-dithiophene)} zirconium dichloride; dimethylsilanediyl{(1-(2,4,7-trimethylindenyl)-7-(2,5-dimethyl-cyclopenta[1,2-b:4,3-b']dithiophene)}Zirconium dichloride; and dimethylsilanediyl{(1-(2,4,7-trimethylindenyl)-7-(2,5-dimethyl-cyclopenta[1,2-b:4,3-b']-dithiophene)}zirconium dimethyl.

In some embodiments, the alumoxanes are selected from the group consisting of methylalumoxane (MAO), tetra-(isobutyl)alumoxane (TIBAO), tetra-(2,4,4-trimethyl-pentyl)alumoxane (TIOAO), tetra-(2,3-dimethylbutyl)alumoxane (TDMBAO), and tetra-(2,3,3-trimethylbutyl)alumoxane (TTMBAO).

In some embodiments, the alkylmetallocene cation is prepared from compounds of formula D⁺E⁻, wherein D⁺ is a Brønsted acid, able to donate a proton and to react irreversibly with a substituent X of the metallocene of formula (I), and E⁻ is a compatible anion, which is able to stabilize the active catalytic species originating from the reaction of the two compounds, and which is able to be removed by an olefinic monomer. In some embodiments, the anion E⁻ is made from or containing one or more boron atoms.

In some embodiments, the organo aluminum compound are selected from the group consisting of trimethylaluminum (TMA), triisobutylaluminum (TIBA), tris(2,4,4-trimethyl-pentyl)aluminum (TIOA), tris(2,3-dimethylbutyl)aluminum (TDMBA), and tris(2,3,3-trimethylbutyl)aluminum (TTMBA).

In some embodiments, the catalyst system and the polymerization processes employing such catalyst system are as described in Patent Cooperation Treaty Publication Nos. WO2004099269 and WO2009000637.

In some embodiments, the polymerization process is carried out with the catalysts by operating in liquid phase, optionally in the presence of an inert hydrocarbon solvent, or in gas phase, using fluidized bed or mechanically agitated gas phase reactors.

In some embodiments, the hydrocarbon solvent is aromatic or aliphatic. In some embodiments, the aromatic solvent is toluene. In some embodiments, the aliphatic solvent is selected from the group consisting of propane, hexane, heptane, isobutane, cyclohexane, 2,2,4-trimethylpentane, and isododecane.

In some embodiments, the polymerization process is carried out by using liquid butene-1 as polymerization medium.

In some embodiments, the polymerization temperature is from 20° C. to 150° C., alternatively from 50° C. to 90° C., alternatively from 65° C. to 82° C.

In some embodiments, a molecular weight regulator, alternatively hydrogen, is fed to the polymerization environment.

In some embodiments, the process is a multistep polymerization process, wherein butene-1 polymers with different composition or molecular weights are prepared in sequence in two or more reactors with different reaction conditions. In some embodiments, the concentration of molecular weight regulator differs. In some embodiments, different comonomers are fed to each reactor.

In some embodiments, the butene-1 polymer is made from or containing components B1) and B2), wherein the polymerization process is carried out in two or more reactors connected in series and components B1) and B2) are prepared in separate subsequent stages, operating in each stage, except for the first stage, in the presence of the polymer formed and the catalyst used in the preceding stage.

In some embodiments, the catalyst is added in the first reactor and not subsequent reactors. In some embodiments, the catalyst is added in more than the first reactor.

In some embodiments, the melt index values of the polymer components are obtained directly in polymerization or by subsequent chemical treatment (chemical visbreaking).

In some embodiments, the chemical visbreaking of the polymer is carried out in the presence of free radical initiators, alternatively peroxides.

In some embodiments, the peroxides have a decomposition temperature ranging from 150° C. to 250° C. In some embodiments, the peroxides are selected from the group consisting of di-tert-butyl peroxide, dicumyl peroxide, 2,5-dimethyl-2,5-di(tert-butylperoxy)hexyne, and 2,5-dimethyl-2,5-di(tert-butylperoxy)hexane. In some embodiments, the peroxides are commercially available.

In some embodiments, the quantity of peroxide ranges from 0.001 to 0.5% by weight, alternatively from 0.001 to 0.2% by weight, based upon the weight of the polymer subject to visbreaking.

As used herein, the term “clarifying agent” refers to an additive which decreases haze of propylene polymers or heterophasic polyolefin compositions made from or containing the propylene polymers.

In some embodiments, the clarifying agent reduces the haze values of the propylene polymers or the heterophasic polyolefin compositions by at least 20%, alternatively by at least 30%, alternatively by at least 50%.

In some embodiments, the clarifying agent is added to a propylene polymer in amounts from 0.025% to 0.2% by weight with respect to the total weight of the propylene polymer and the clarifier.

In some embodiments, the clarifying agents belong to the class of nucleating agents.

In some embodiments, the clarifying agents are selected from the group consisting of derivatives of polyols, phosphate ester salts, and carboxylic acid salts. In some embodiments, the derivatives are acetals. In some embodiments, the polyols are selected from the group consisting of sorbitol, xylitol, and nonitol.

In some embodiments, the acetals of sorbitol and xylitol are selected from the group consisting of dibenzylidene sorbitol; di(alkylbenzylidene) sorbitols; bis(3,4-dialkylbenzylidene) sorbitols; bis(5′,6′,7′,8′-tetrahydro-2-naphthylidene) sorbitol; bis(trimethylbenzylidene) xylitol; and bis(trimethylbenzylidene) sorbitol. In some embodiments, the di(alkylbenzylidene) sorbitols are selected from the group consisting of di(p-methylbenzylidene) sorbitol, di(o-methylbenzylidene) sorbitol, and di(p-ethylbenzylidene) sorbitol. In some embodiments, the bis(3,4-dialkylbenzylidene) sorbitols are selected from the group consisting of 1,3;2,4-bis(3,4-dimethylbenzylidene) sorbitol and bis(3,4-diethylbenzylidene) sorbitol.

In some embodiments, the sorbitol acetals, the xylitol acetals, and the use of the acetals as clarifying agents are as described in U.S. Pat. No. 5,310,950.

In some embodiments, the clarifying agents are commercially available as MILLAD® 3988 powdered 1,3;2,4-Bis(3,4-dimethylbenzylidene) sorbitol; MILLAD® NX™ 8000 1,2,3-trideoxy-4,6:5,7-bis-O-[(4-propylphenyl)methylene]-nonitol; and MILLAD® NX™ 8500E nonitol-based clarifying agent.

In some embodiments, the clarifying agents are commercially-available phosphate ester salts selected from the group consisting of NA-11 sodium 2,2′-methylene-bis-(4,6-di-tert-butylphenyl)phosphate, NA-21 aluminum hydroxy bis[2,2′-methylene-bis-(4,6-di-tert-butylphenyl)phosphate], and NA-71, which are commercially available from Adeka Corporation.

In some embodiments, the clarifying agents are carboxylic acid salts. In some embodiments, the carboxylic acid salts are selected from the group consisting of dicarboxylic acid salts and cyclohexane dicarboxylate salts. In some embodiments, the dicarboxylic acid salts are bicyclo[2.2.1]heptane dicarboxylate salts, alternatively Hyperform® HPN-68L, which is based on endo-norbornane-2,3-dicarboxylic acid disodium salt. In some embodiments, the cyclohexane dicarboxylate salt is Hyperform® HPN-20E, which is based on cyclohexane-1,2-dicarboxylic acid calcium salt.

In some embodiments, the clarifying agents are selected from the group consisting of di(alkylbenzylidene) sorbitols, bis(3,4-dialkylbenzylidene) sorbitols, in particular 1,3-O-2,4-bis(3,4-dimethylbenzylidene) sorbitol, and nonitol derivatives. In some embodiments, the bis(3,4-dialkylbenzylidene) sorbitol is 1,3-O-2,4-bis(3,4-dimethylbenzylidene) sorbitol. In some embodiments, the nonitol derivative is 1,2,3-trideoxy-4,6:5,7-bis-O-[(4-propylphenyl)methylene]-nonitol.

In some embodiments, the clarifying agent C) is added in an amount from 0.02% to 0.3% by weight, alternatively from 0.05% to 0.25% by weight, alternatively from 0.05% to 0.2% by weight, alternatively from 0.1% to 0.2% by weight, with respect to the total weight of A)+B)+C).

In some embodiments, the polyolefin composition is made from or containing:
A) from 97.7% to 99.97% by weight, alternatively from 98.25% to 99.935% by weight, alternatively from 99.3% to 99.93% by weight, alternatively from 99.5% to 99.88% by weight, of a propylene polymer, alternatively a heterophasic polyolefin composition made from or containing the propylene polymer and an ethylene copolymer;
B) from 0.01% to 2% by weight, alternatively from 0.015% to 1.5% by weight, alternatively from 0.02% to 0.5% by weight, alternatively from 0.02% to 0.3% by weight, alternatively from 0.02% to 0.2% by weight, of a butene-1 polymer; and
C) from 0.02% to 0.3% by weight, alternatively from 0.05% to 0.25% by weight, alternatively from 0.05% to 0.2% by weight, alternatively from 0.1% to 0.2% by weight, of a clarifying agent,
wherein the amounts of A), B) and C) are referred to the total weight of A)+B)+C).

In some embodiments, the weight ratio C)/B) is from 0.5 to 4, alternatively from 1 to 3.5.

In some embodiments, the polyolefin composition is further made from or containing additives, fillers, stabilizing agents (against heat, light, or U.V.), plasticizers, antiacids, antistatic agents, water repellant agents, organic pigments, and inorganic pigments.

In some embodiments, the polyolefin composition has at least one of the following features:
Haze values, measured according to ASTM D 1003-13 on 1 mm plaque, equal to or lower than 20%, alternatively equal to or lower than 15%; or
MIL from 0.1 to 400 g/10 min., alternatively from 0.5 to 150 g/10 min., alternatively from 10 to 100 g/10 min.; or
Elongation at break, according to ISO 527-1:2019 on compression-molded plaques, measured 10 days after molding, from 500 to 1500%; or
Charpy notched at 23° C., according to ISO 179/1eA:2010, measured 48 hours after molding, from 2 to 10 kJ/m²; or
Charpy notched at 0° C., according to ISO 179/1eA:2010, measured 48 hours after molding, from 1 to 5 kJ/m²; or
Melting temperature from 142 to 153° C.; or
Crystallization temperature from 114 to 120° C. In some embodiments, the lower limit of the haze values is 2%.

In some embodiments, the polyolefin composition is prepared by blending the components at temperatures from 180 to 310° C., alternatively from 190 to 280° C., alternatively from 200 to 250° C.

In some embodiments, the melt-blending apparatuses are extruders or kneaders, alternatively twin-screw extruders. In some embodiments, the components are premixed at room temperature in a mixing apparatus.

In some embodiments, the polyolefin composition, in the form of the premixed components, is directly fed to the processing equipment used to prepare the final article, thereby omitting a melt-blending step.

In some embodiments, the polyolefin composition is for preparing injection-molded articles, alternatively inj ection-blow-molded and inj ection-stretch-blow-molded articles. In some embodiments, the articles are bottles and containers.

In some embodiments, the present disclosure provides an injection-molded article made from or containing the polyolefin composition. In some embodiments, the injection-molded article has a wall thickness equal to or greater than 0.1 mm, alternatively equal to or greater than 0.5 mm.

In some embodiments, the injection-molding process includes the steps of melting the polyolefin composition and injecting the molten polymer composition in the mold under pressure. In some embodiments, the resulting article is an injection-molded tubular structure, wherein the structure was formed by blowing air into the molten polymer composition and forcing the resulting tube to conform to the inside walls of the mold.

In some embodiments, the injection-molding process uses melt temperatures from 180 to 230° C. with injection pressures from 1 to 150 MPa.

### EXAMPLES

The following examples are given to illustrate, not limit, the scope of the present disclosure.

The following analytical methods are used to characterize the polymer compositions.

MIE and MIP

Determined according to norm ISO 1133-2:2011 under the specified temperature and load.

Comonomer Contents

Propylene Polymer A)

For propylene copolymers, the comonomer content was determined by infrared spectroscopy by collecting the IR spectrum of the sample vs. an air background with a Fourier Transform Infrared spectrometer (FTIR). The instrument data acquisition parameters were:
purge time: 30 seconds minimum;
collect time: 3 minutes minimum;
apodization: Happ-Genzel;
resolution: 2 cm⁻¹.

Sample Preparation

Using a hydraulic press, a thick sheet was obtained by pressing about 1 gram of sample between two aluminum foils. If homogeneity was uncertain, a minimum of two pressing operations occurred. A small portion was cut from this sheet to mold a film. The film thickness was between 0.02-:0.05 cm (8-20 mils).

Pressing temperature was 180±10° C. (356° F.) and at about 10 kg/cm² (142.2 PSI) pressure for about one minute. Then the pressure was released, and the sample was removed from the press and cooled to room temperature.

The spectrum of a pressed film of the polymer was recorded in absorbance vs. wavenumbers (cm⁻¹). The following measurements were used to calculate ethylene and butene-1 content:
Area (At) of the combination absorption bands between 4482 and 3950 cm⁻¹ which was used for spectrometric normalization of film thickness.
If ethylene was present, Area (AC2) of the absorption band between 750-700 cm⁻¹ after two proper consecutive spectroscopic subtractions of an isotactic non-additive-containing polypropylene spectrum was measured and then, if butene-1 was present, of a standard spectrum of a butene-1-propylene random copolymer in the range 800-690 cm⁻¹ was used.
If butene-1 was present, the height (DC4) of the absorption band at 769 cm⁻¹ (maximum value), after two proper consecutive spectroscopic subtractions of an isotactic non-additive-containing polypropylene spectrum was measured and then, if ethylene was present, of a standard spectrum of an ethylene-propylene random copolymer in the range 800-690 cm⁻¹ was used.

To calculate the ethylene and butene-lcontent, calibration straight lines for ethylene and butene-1 were obtained by using standards of ethylene and butene-1.

Butene-1 Polymer B)

Comonomer contents were determined via FT-IR.

The spectrum of a pressed film of the polymer was recorded in absorbance vs. wavenumbers (cm⁻¹). The following measurements were used to calculate the ethylene content:
a) area (Aₜ) of the combination absorption bands between 4482 and 3950 cm⁻¹ which was used for spectrometric normalization of film thickness.
b) factor of subtraction (FCR_{C2}) of the digital subtraction between the spectrum of the polymer sample and the absorption band due to the sequences BEE and BEB (B: 1,butene units, E: ethylene units) of the methylenic groups (CH₂ rocking vibration).
c) Area (A_{C2,block}) of the residual band after subtraction of the C₂PB spectrum, which comes from the sequences EEE of the methylenic groups (CH₂ rocking vibration).

Apparatus

A Fourier Transform Infrared spectrometer (FTIR) was used.

A hydraulic press with platens heatable to 200° C. (Carver or equivalent) was used.

Method

Calibration of (BEB+BEE) Sequences

A calibration straight line was obtained by plotting % (BEB+BEE)wt vs. FCR_{C2}/Aₜ. The slope Gᵣ and the intercept Iᵣ were calculated from a linear regression.

Calibration of EEE Sequences

A calibration straight line was obtained by plotting % (EEE)wt vs. A_{C2,block}/Aₜ. The slope G_{H} and the intercept I_{H} were calculated from a linear regression.

Sample Preparation

Using a hydraulic press, a thick sheet was obtained by pressing about 1.5 grams of sample between two aluminum foils. If homogeneity was uncertain, a minimum of two pressing operations occurred. A small portion was cut from this sheet to mold a film. The film thickness was between 0.1-0.3 mm.

The pressing temperature was 140±10° C.

Because a crystalline phase modification takes place with time, the IR spectrum of the sample film was collected as soon as the sample was molded.

Procedure

The instrument data acquisition parameters were as follows:
Purge time: 30 seconds minimum.
Collect time: 3 minutes minimum.
Apodization: Happ-Genzel.
Resolution: 2 cm⁻¹.
Collect the IR spectrum of the sample vs. an air background.

Calculation

Calculate the concentration by weight of the BEE+BEB sequences of ethylene units:

$$\% ( BEE + BEB ) wt = {G}_{r} \cdot \frac{{FCR}_{C 2}}{{A}_{t}} + {I}_{r}$$

Calculate the residual area (AC2,block) after the subtraction described above, using a baseline between the shoulders of the residual band.

Calculate the concentration by weight of the EEE sequences of ethylene units:

$$\% ( EEE ) wt = {G}_{H} \cdot \frac{{A}_{C 2 , block}}{{A}_{t}} + {I}_{H}$$

Calculate the total amount of ethylene percent by weight:

% C2wt=[% (BEE+BEB)wt+% (EEE)wt]

Haze

Measured according to ASTM D 1003-13 on 1 mm plaque. According to the method used, 7.5×7.5 cm specimens were cut from molded plaques 1 mm thick. The haze value was measured using a Gardner photometric unit connected to a Hazemeter type UX-10 or an equivalent instrument having G.E. 1209 light source with filter “C”. Standards were used for calibrating the instrument.

The plaques to be tested were produced according to the following method.

75×75×1 mm plaques were molded with a GBF Plastinjector G235/90 Injection Molding Machine, 90 tons under the following processing conditions:
Screw rotation speed: 120 rpm;
Back pressure: 10 bar;
Melt temperature: 230° C.;
Injection time: 5 sec;
Switch to hold pressure: 50 bar;
First stage hold pressure: 43 bar;
Second stage pressure: 20 bar;
Hold pressure profile: First stage 5 sec;
Second stage 10 sec;
Cooling time: 20 sec;
Mold water temperature: 40° C.

Gloss

Specular gloss properties were measured at an angle of 60° using a micro-TRI-gloss meter made by BYK-Gardner GmbH in conformance with ASTM D 523-14(2018) using a black felt backing. The gloss meter was calibrated using a black glass.

Tensile Modulus

Measured according to ISO 527-2:2012.

Charpy Impact Strength

According to ISO 179/1eA:2010 at 23° C. and 0° C., measured 48 hours after molding.

Tensile Stress and Elongation at Yield and at Break

According to norm ISO 527-1:2019 on compression molded plaques, measured 10 days after molding.

Flexural Modulus

According to norm ISO 178:2019, measured 48 hours after molding.

Brookfield Viscosity

Measured at 190° C. by a Cylindrical Spindle Rotational Viscometer HA Ametek/Benelux Scientific model DV2T, equipped with a drive motor capable of variable testing speed and a set of spindles capable of achieving and maintaining a torque at about 80%.

The spindle/chamber combination was SC4-27/SC4-13R/RP.

During the test, the sample was subjected to a stepwise rotation increase until a torque value of around 80% was reached and maintained. Rotation started at 10 RPM then increased stepwise by 2 RPM per 5 seconds.

The Brookfield viscosity, expressed in mPa*s, was calculated as Shear Stress (mPa)/Shear Rate (sec-1) ratio and determined by averaging the results obtained during the last 20 minutes of acquisition (1 datapoint/minute).

Intrinsic Viscosity (I.V.)

Determined according to norm ASTM D 2857-16 in tetrahydronaphthalene at 135° C.

Polydispersity Index (PI)

Determined at a temperature of 200° C. by using a parallel plates rheometer model RMS-800 marketed by RHEOMETRICS (USA), operating at an oscillation frequency increasing from 0.1 rad/sec to 100 rad/sec. From the crossover modulus, the P.I. was derived from the equation:

P.I.=10⁵/Gc

wherein Gc is the crossover modulus which is defined as the value (expressed in Pa) at which G′=G″
wherein G′ is the storage modulus and G″ is the loss modulus.

Fractions Soluble and Insoluble in Xylene at 25° C. (XS-25° C.)

2.5 g of polymer were dissolved in 250 ml of xylene at 135° C. under agitation. After 20 minutes, the solution was allowed to cool to 25° C., under agitation, and then allowed to settle for 30 minutes. The precipitate was filtered with filter paper. The solution evaporated in nitrogen flow. The residue was dried under vacuum at 80° C. until constant weight was reached. The percent by weight of polymer soluble (Xylene Solubles—XS) and insoluble at room temperature (25° C.) were calculated.

As used herein, the term “isotactic index of a polymer” approximates the percent by weight of polymer insoluble in xylene at room temperature (25° C.). It is believed that this value corresponds to the isotactic index determined by extraction with boiling n-heptane, which by definition constitutes the isotactic index of propylene polymers.

Fractions Soluble and Insoluble in Xylene at 0° C. (XS-0° C.)

2.5 g of the polymer sample were dissolved in 250 ml of xylene at 135° C. under agitation. After 30 minutes, the solution was allowed to cool to 100° C., under agitation, and then placed in a water and ice bath to cool down to 0° C. Then, the solution was allowed to settle for 1 hour in the water and ice bath. The precipitate was filtered with filter paper. During the filtering, the flask was left in the water and ice bath, thereby keeping the flask inner temperature as near to 0° C. as possible. Once the filtering was finished, the filtrate temperature was balanced at 25° C., dipping the volumetric flask in a water-flowing bath for about 30 minutes. Then, the flask contents were divided in two 50 ml aliquots. The solution aliquots were evaporated in nitrogen flow, and the residue was dried under vacuum at 80° C. until a constant weight was reached. If the weight difference between the two residues was less than 3%, the test was terminated. If the weight difference between the two residues was not less than 3%, the test was repeated. The percent by weight of polymer soluble (Xylene Solubles at 0° C.=XS 0° C.) was calculated from the average weight of the residues. The insoluble fraction in o-xylene at 0° C. (xylene Insolubles at 0° C.=XI % 0° C.) was:

XI % 0° C.=100−XS % 0° C.

Melting and Crystallization Temperatures of Butene-1 Polymer B) via Differential Scanning Calorimetry (DSC)

Differential scanning calorimetric (DSC) data were obtained with a Perkin Elmer DSC-7 instrument, using a weighed sample (5-10 mg) sealed into aluminum pans.

To determine the melting temperature of the polybutene-1 crystalline form I (TmI), the sample was heated to 200° C. with a scanning speed corresponding to 10° C./minute, kept at 200° C. for 5 minutes, and then cooled down to 20° C. with a cooling rate of 10° C./min. The sample was then stored for 10 days at room temperature. After 10 days, the sample was subjected to DSC, cooled to −20° C., and then heated to 200° C. with a scanning speed corresponding to 10° C./min. In this heating run, the highest temperature peak in the thermogram was taken as the melting temperature (TmI).

To determine the melting temperature of the polybutene-1 crystalline form II (TmII) and the crystallization temperature T_{c}, the sample was heated to 200° C. with a scanning speed corresponding to 10° C./minute and kept at 200° C. for 5 minutes, thereby allowing melting of the crystallites and cancelling the thermal history of the sample. Successively, by cooling to −20° C. with a scanning speed corresponding to 10° C./minute, the peak temperature was taken as crystallization temperature (T_{c}) and the area as the crystallization enthalpy. After standing 5 minutes at −20° C., the sample was heated for the second time to 200° C. with a scanning speed corresponding to 10° C./min. In this second heating run, the peak temperature was taken as the melting temperature of the polybutene-1 crystalline form II (TmII) and the area as the melting enthalpy (4EM).

NMR Analysis of Chain Structure

¹³C NMR spectra were acquired on a Bruker AV-600 spectrometer equipped with cryo-probe, operating at 150.91 MHz in the Fourier transform mode at 120° C.

The peak of the T_{βδ} carbon (nomenclature according to C. J. Carman, R. A. Harrington and C. E. Wilkes, Macromolecules, 10, 3, 536 (1977)) was used as internal standard at 37.24 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing ¹H-¹³C coupling. About 512 transients were stored in 32K data points using a spectral window of 9000 Hz.

The assignments of the spectra, the evaluation of triad distribution and the composition were made according to Kakugo [M. Kakugo, Y. Naito, K. Mizunuma and T. Miyatake, Macromolecules, 16, 4, 1160 (1982)] and Randall [J. C. Randall, Macromol. Chem Phys., C30, 211 (1989)] using the following:

BBB=100 (T_{ββ})/S =I5

BBE=100T_{βδ}/S=I4

EBE=100P_{δδ}/S=I14

BEB=100S_{ββ}/S=I13

BEE=100S_{αδ}/S=I7

EEE=100(0.25S_{γδ}+0.5S_{δδ})/S=0.25I9+0.5I10

| Area | Chemical Shift | Assignments | Sequence |
|---|---|---|---|
| 1 | 40.40-40.14 | Sαα | BBBB |
| 2 | 39.64 | Tδδ | EBE |
| | 39-76-39.52 | Sαα | BBBE |
| 3 | 39.09 | Sαα | EBBE |
| 4 | 37.27 | Tβδ | BBE |
| 5 | 35.20-34.88 | Tββ | BBB |
| 6 | 34.88-34.49 | Sαγ | BBEB + BEBE |
| 7 | 34.49-34.00 | Sαδ | EBEE + BBEE |
| 8 | 30.91 | Sγγ | BEEB |
| 9 | 30.42 | Sγδ | BEEE |
| 10 | 29.90 | Sδδ | EEE |
| 11 | 27.73-26.84 | Sβδ + 2B₂ | BBB + BBE |
| | | | EBEE + BBEE |
| 12 | 26.70 | 2B₂ | EBE |
| 13 | 24.54-24.24 | Sββ | BEB |
| 14 | 11.22 | Pδδ | EBE |
| 15 | 11.05 | Pβδ | BBE |
| 16 | 10.81 | Pββ | BBB |

To a first approximation, the mmmm was calculated using 2B2 carbons as follows:

| Area | Chemical shift | assignments |
|---|---|---|
| B1 | 28.2-27.45 | mmmm |
| B2 | 27.45-26.30 | |

mmmm = B₁*100/(B₁ + B₂-2*A₄-A₇-A₁₄)

Molecular Weights Determination by GPC

Measured by way of Gel Permeation Chromatography (GPC) in 1,2,4-trichlorobenzene (TCB). Molecular weight parameters (Mn, Mw) and molecular weight distributions Mw/Mn for the samples were measured by using a GPC-IR apparatus by PolymerChar, which was equipped with a column set of four PLgel Olexis mixed-bed (Polymer Laboratories) and an IR5 infrared detector (PolymerChar). The dimensions of the columns were 300×7.5 mm, and the particle size was 13 μm. The mobile phase flow rate was kept at 1.0 mL/min. The measurements were carried out at 150 ° C. Solution concentrations were 2.0 mg/mL (at 150° C.), and 0.3 g/L of 2,6-di-tert-butyl-p-cresol were added to prevent degradation. For GPC calculation, a universal calibration curve was obtained using 12 polystyrene (PS) standard samples supplied by PolymerChar (peak molecular weights ranging from 266 to 1220000). A third-order polynomial fit was used for interpolating the experimental data and obtaining the relevant calibration curve. Data acquisition and processing was done by using Empower 3 (Waters). The Mark-Houwink relationship was used to determine the molecular weight distribution and the relevant average molecular weights: the K values were K_{PS}=1.21×10⁻⁴ dL/g and K_{PB}=1.78×10⁻⁴ dL/g for PS and polybutene (PB) respectively, while the Mark-Houwink exponents α=0.706 for PS and α=0.725 for PB were used.

For butene/ethylene copolymers, the composition of each sample was assumed constant in the whole range of molecular weight, and the K value of the Mark-Houwink relationship was calculated using a linear combination as reported below:

K_{EB}=x_{E}K_{PE}+x_{B}K_{PB}

where K_{EB} is the constant of the copolymer, K_{PE} (4.06×10⁻⁴, dL/g) and K_{PB} (1.78×10⁻⁴ dL/g) are the constants of polyethylene (PE) and PB, x_{E} and x_{B} are the ethylene and the butene weight relative amount with x_{E}+x_{B}=1. The Mark-Houwink exponents α=0.725 was used for the butene/ethylene copolymers independently of composition. End processing data treatment was fixed for the samples to include fractions up at 1000 in terms of molecular weight equivalent. Fractions below 1000 were investigated via GC.

Determination of X-Ray Crystallinity

The X-ray crystallinity was measured with an X-ray Diffraction Powder Diffractometer (XDPD) that uses the Cu-Kα1 radiation with fixed slits and able to collect spectra between diffraction angle 2Θ=5° and 2Θ=35° with step of 0.1° per 6 seconds.

The samples were diskettes of about 1.5-2.5 mm of thickness and 2.5-4.0 cm of diameter made by compression-molding. The diskettes were aged at room temperature (23° C.) for 96 hours.

After this preparation, the specimen was inserted in the XDPD sample holder. The XRPD instrument was set to collect the XRPD spectrum of the sample from diffraction angle 2Θ=5° to 2Θ=35° with steps of 0.1° by using counting time of 6 seconds. At the end, the final spectrum was collected.

As used herein, the term “Ta” refers to the total area between the spectrum profile and the baseline, expressed in counts/sec·2Θ. As used herein, the term “Aa” refers to the total amorphous area, expressed in counts/sec·2Θ. As used herein, the term “Ca” refers to total crystalline area, expressed in counts/sec·2Θ.

The spectrum or diffraction pattern was analyzed in the following steps:
1) define a linear baseline for the whole spectrum and calculate the total area (Ta) between the spectrum profile and the baseline;
2) define an amorphous profile, along the whole spectrum, that separate the amorphous regions from the crystalline ones according to the two-phase model;
3) calculate the amorphous area (Aa) as the area between the amorphous profile and the baseline;
4) calculate the crystalline area (Ca) as the area between the spectrum profile and the amorphous profile as Ca=Ta−Aa; and
5) calculate the degree of crystallinity (% Cr) of the sample using the formula:

% Cr=100×Ca/Ta

Density

Measured according to ISO 1183-1:2012 at 23° C.

Glass Transition Temperature via DMTA (Dynamic Mechanical Thermal Analysis) Molded specimens of 76 mm by 13 mm by 1 mm were fixed to a DMTA machine for tensile stress. The frequency of the tension and relies of the sample was fixed at 1 Hz. The DMTA translated the elastic response of the specimen starting from −100° C. to 130° C. The elastic response was plotted versus temperature. The elastic modulus for a viscoelastic material was defined as E=E′+iE″. In some instances, the DMTA split the two components E′ and E″ by resonance and plotted E′ vs temperature and E′/E″=tan (δ) vs temperature.

The glass transition temperature Tg was assumed to be the temperature at the maximum of the curve E′/E″=tan (δ) vs temperature.

Melting Temperature and Crystallization Temperatures of the Polyolefin Composition

Measured by using a DSC instrument according to ISO 11357-3:2018, at scanning rate of 20° C./min in cooling and heating, on a sample of weight between 5 and 7 mg, under inert N2 flow. Instrument calibration made with Indium.

Materials

The hereinafter described materials were used in the following examples.

Propylene Polymer A)

Copolymer of propylene with 3% by weight of ethylene, having the following properties:
MIL of 75 g/10 min.;
Haze of 56.4%;
Gloss of 97.1;
Fraction insoluble in xylene at 25° C. of 94% by weight;
Flexural modulus of about 1000 MPa.

Butene-1 Polymer B)

Two different polymers were used, including butene-1 polymer B)-I and butene-1 polymer B)-II.

Butene-1 Polymer B)-I

Prepared as reported hereinafter.

Preparation of the Catalytic Solution

Under nitrogen atmosphere, 6400 g of a 33 g/L solution of triisobutylaluminum (TIBA) in isododecane and 567 g of 30% wt/wt solution of methylalumoxane (MAO) in toluene were loaded in a 20 L jacketed glass reactor, stirred by an anchor stirrer, and allowed to react at room temperature for about 1 hour under stirring.

After this time, 1.27 g of metallocene dimethylsilyl{(2,4,7-trimethyl-1-indenyl)-7-(2,5-dimethyl-cyclopenta[1,2-b:4,3-b′]-dithiophene)} zirconium dichloride, prepared as described in Example 32 of Patent Cooperation Treaty Publication No. WO0147939, was added and dissolved under stirring for about 30 minutes.

The final solution was discharged from the reactor into a cylinder through a filter, thereby removing solid residues.

The composition of the resulting solution was as follows:

| Al | Zr | Al/Zr | metallocene |
|---|---|---|---|
| (wt. %) | (wt. %) | (mol ratio) | conc. (mg/l) |
| 1.72 | 0.0029 | 2001 | 137 |

Polymerization

The polymerization was carried out in two stirred reactors operated in series, wherein liquid butene-1 constituted the liquid medium. The catalyst solution was fed in both reactors. The polymerization conditions are reported in Table 1. The butene-1/ethylene copolymer was recovered as melt from the solution and cut in pellets. The copolymer was analyzed, and the data are reported in Table 2.

TABLE 1

| First Reactor | | |
|---|---|---|
| Temperature | ° C. | 75 |
| H₂ in liquid phase | molar ppm | 3248 |
| C₂₋ in liquid phase | wt. % | 0.3 |
| Mileage | Kg/gMe | 1485 |
| Split | wt. % | 60 |
| C₂₋ content | wt. % | 1 |
| C₂₋ content | mole % | 1.98 |
| Second Reactor | | |
| Temperature | ° C. | 75 |
| H₂ in liquid phase | molar ppm | 3248 |
| C₂₋ in liquid phase | wt. % | 0.4 |
| Split | wt. % | 40 |
| C₂₋ content | wt. % | 1 |
| C₂₋ content | mole % | 1.98 |
| Total mileage | Kg/gMe | 1539 |
| Total C₂₋ content | wt. % | 1.0 |
| Total C₂₋ content | mole % | 1.98 |

Note:
C₂₋ = ethylene; kg/gMe = kilograms of polymer per gram of metallocene; Split = amount of polymer produced in each reactor.

TABLE 2

| | | |
|---|---|---|
| MIE (190° C./2.16 Kg) | g/10 min. | 1200 |
| Intrinsic viscosity (IV) | dl/g | 0.4 |
| Mw/Mn | | 2.1 |
| TmII | ° C. | 81.9 |
| TmI | ° C. | 103 |
| Tg | ° C. | −13 |
| Brookfield Viscosity | mPa · s | 6900 |
| (180° C.) | | |
| Crystallinity (X-ray) | % | 58 |
| Density | g/cm³ | 0.9090 |
| Flexural modulus | MPa | 350 |

Butene-1 Polymer B)-II

Using the same catalytic solution and the same polymerization equipment as used for the preparation of the butene-1 polymer B)-I, the polymerization was carried out in the two stirred reactors operated in series, wherein liquid butene-1 constituted the liquid medium. The catalyst solution was injected in both reactors, and the polymerization was carried out continuously at a polymerization temperature of 75° C. The residence time in each reactor was in a range of 120÷200 min. The concentration of hydrogen, during polymerization, was 4900 ppm mol H₂/(C₄₋) bulk, where C₄₋=butene-1. The comonomer was fed to the reactors in an amount of C₂₋/C₄₋0.35% wt. The ethylene comonomer was almost immediately copolymerized (C2−“stoichiometric” feed to the reactor). The catalyst yield (mileage) was of 2000 kg/g metallocene active component. The butene-1 copolymer was recovered as melt from the solution and cut in pellets. The copolymer was analyzed, and the data are reported in Table 3.

TABLE 3

| | | |
|---|---|---|
| MIE | g/10 min. | 2500 |
| C₂₋ (IR) | wt. % | 1.1 |
| IV | dl/g | 0.34 |
| Mw/Mn | | 2.1 |
| TmII | ° C. | 83.5 |
| TmI | | 103 |
| Tg | ° C. | −13 |
| Brookfield Viscosity | mPa · s | 3200 |
| (180° C.) | | |
| Crystallinity (X-ray) | % | 55 |
| Density | g/cm³ | 0.912 |
| Flexural Modulus | MPa | 300-350 |

Clarifying Agent C)

1,3;2,4-Bis(3,4-dimethylbenzylidene) sorbitol was commercially available from Milliken under the tradename Millad 3988.

Preparation of the Polyolefin Compositions

Examples 1-4 and Comparative Example 1

Components A), B) and C) were blended in the amounts reported in Table 4, wherein also the final properties of the resulting polyolefin compositions are reported.

Blending was carried out by extrusion with composition of stabilizing additives in a twin screw extruder Berstorff ZE 25 (length/diameter ratio of screws: 34) under nitrogen atmosphere in the following conditions:
Rotation speed: 250 rpm;
Extruder output: 15 kg/hour;
Melt temperature: 245° C.

The composition of stabilizing additives was made from or containing 500 ppm of Irganox 1010 pentaerythritol tetrakis(3-(3,5-di-tert-butyl-4-hydroxyphenyl)propionate), which was commercially available from BASF, 1000 ppm of Irgafos 168 tris(2,4-di-tert-butylphenyl) phosphite, which was commercially available from BASF, 500 ppm of calcium stearate, and 1000 ppm of GMS90 glycerol monostearate, which was commercially available from Croda. The composition was added in an amount of 0.3% by weight, based upon the total weight of the polyolefin composition.

TABLE 4

| Example No. | | 1 | 2 | 3 | 4 | Comp. 1 |
|---|---|---|---|---|---|---|
| A) amount* | % wt. | 99.475 | 99.455 | 99.475 | 99.455 | 99.52 |
| B)-I amount* | % wt. | 0.065 | 0.065 | — | — | — |
| B)-II amount* | % wt. | — | — | 0.065 | 0.065 | — |
| C) amount* | % wt. | 0.16 | 0.18 | 0.16 | 0.18 | 0.18 |
| Additives* | % wt. | 0.3 | 0.3 | 0.3 | 0.3 | 0.3 |
| A) amount** | % wt. | 99.774 | 99.754 | 99.774 | 99.754 | 99.819 |
| B)-I amount** | % wt. | 0.065 | 0.065 | — | — | — |
| B)-II amount** | % wt. | — | — | 0.065 | 0.065 | — |
| C) amount** | % wt. | 0.16 | 0.18 | 0.16 | 0.18 | 0.18 |
| Haze | % | 10.90 | 10.10 | 10.60 | 9.21 | 14.80 |
| Gloss a 60° | GU | 134.0 | 132.0 | 134.0 | 136.0 | 136.0 |
| Tensile Modulus | N/mm² | 1110 | 1155 | | 1120 | 1136 |
| Charpy | kJ/m² | 4.4 | 3.9 | — | 4.4 | 4.6 |
| Notched @23° C. | | | | | | |
| Charpy | kJ/m² | 1.5 | 1.7 | — | 1.5 | 1.4 |
| Notched @0° C. | | | | | | |
| Tensile | N/mm² | 27.9 | 28.7 | — | 28.3 | 28.8 |
| Stress @ Yield | | | | | | |
| Elongation @ Yield | % | 13.5 | 13.3 | — | 13.3 | 13.2 |
| Tensile | N/mm² | 15.6 | 13.0 | — | 16.3 | 12.0 |
| Stress @ Break | | | | | | |
| Elongation @ | % | 840.0 | 752.0 | — | 720.0 | 676.0 |
| Break | | | | | | |
| Melting | ° C. | 147.5 | 148.2 | 147.9 | 148.2 | 147.9 |
| Temperature | | | | | | |
| Crystallization | ° C. | 116.8 | 117.4 | 117.5 | 117.3 | 117.1 |
| Temperature | | | | | | |

*with respect to the total weight of the polyolefin composition;
**with respect to total weight of A) + B) + C).

1. A polyolefin composition comprising:
A) a propylene polymer;
B) from 0.01% to 2% by weight of a butene-1 polymer; and
C) a clarifying agent,
wherein the amounts are referred to the total weight of A)+B)+C).

2. The polyolefin composition of claim 1, having a haze value, measured according to ASTM D 1003-13 on 1 mm plaque, equal to or lower than 20%.

3. The polyolefin composition of claim 1, comprising:
A) from 97.7% to 99.97% by weight;
B) from 0.01% to 2% by weight of a butene-1 polymer; and
C) from 0.02% to 0.3% by weight of a clarifying agent,
wherein the amounts of A), B), and C) are referred to the total weight of A)+B)+C).

4. The polyolefin composition of claim 1, wherein the weight ratio C)/B) is from 0.5 to 4.

5. The polyolefin composition of claim 1, having a MIL from 0.1 to 400 g/10 min., where MIL is the melt flow index at 230° C. with a load of 2.16 kg, determined according to ISO 1133-2:2011.

6. The polyolefin composition of claim 1, wherein the propylene polymer A) is selected from the group consisting of propylene homopolymers, propylene copolymers, and mixtures thereof, and the butene-1 polymer B) is selected from the group consisting of butene-1 homopolymers, butene-1 copolymers and mixtures thereof.

7. The polyolefin composition of claim 6, wherein the propylene polymer A) has at least one of the following features:
being a propylene copolymer having a content of comonomer(s) from 0.5 to 15% by weight, wherein the comonomer is ethylene or hexene-1; or
a polydispersity Index (P.I.) equal to or higher than 4; or
a MIL from 0.1 to 400 g/10 min.;
an amount of fraction insoluble in xylene at 25° C. equal to or higher than 85% by weight; or
a flexural modulus higher than 200 MPa.

8. The polyolefin composition of claim 1, wherein the butene-1 polymer B) has a MIE value of from 1 to 3000 g/10 min., where MIE is the melt flow index at 190° C. with a load of 2.16 kg, determined according to ISO 1133-2:2011.

9. The polyolefin composition of claim 1, wherein the butene-1 polymer B) has a copolymerized comonomer content of from 0.5% to 4.0% by mole.

10. The polyolefin composition of claim 1, wherein the butene-1 polymer B) has at least one of the following features:
a) a molecular weight distribution (Mw/Mn) equal to or lower than 9; or
b) a melting point TmII, measured by DSC (Differential Scanning calorimetry) in the second heating run with a scanning speed of 10° C./min., equal to or lower than 125° C.; or
c) a Brookfield viscosity at 190° C. of from 1500 to 20000 mPa·sec; or
d) 4,1 insertions not detectable using a ¹³C-NMR operating at 150.91 MHz; or
e) X-ray crystallinity of from 25 to 65%; or
f) a glass transition temperature (Tg) from −40° C. to −10° C.

11. The polyolefin composition of claim 1, wherein the clarifying agent C) is selected from the group consisting of derivatives of polyols, phosphate ester salts, and carboxylic acid salts.

12. The polyolefin composition of claim 11, wherein the clarifying agent C) is a derivative of polyol selected from the group consisting of di(alkylbenzylidene) sorbitols, bis(3,4-dialkylbenzylidene) sorbitols and nonitol derivatives.

13. An article of manufacture comprising the polyolefin composition of claim 1.

14. A process for reducing the haze of a polyolefin composition comprising:
A) a propylene polymer; and
C) a clarifying agent; comprising the step of adding a butene-1 polymer B) to the polyolefin composition in an amount from 0.01% to 2% by weight, with respect to the total weight of A)+B)+C).

15. The polyolefin composition according to claim 1, wherein component A further comprises an ethylene polymer, thereby forming a heterophasic polyolefin composition.
